(19) United States
(12) Patent Application Publication
(10) Pub. No.: US 2008/0154795 A1
(43) Pub. Date: Jun. 26, 2008

(54) AUCTION PLATFORM AND APPLICATIONS

(76) Inventors: Amos Alon, Haifa (IL); Tsafrir Lavi, Kiriat Ono (IL); Amit Lavi, Petach-Tikva (IL); Yaniv Zah, Fort Lauderdale, FL (US)

Correspondence Address: Naomi Assia Law Offices;C/O Landon IP Inc., Suite 450, 1700 Diagonal Road, Alexandria, VA, 22314, US

(21) Appl. No.: 11/962,826

(22) Filed: Dec. 21, 2007

Related U.S. Application Data
(60) Provisional application No. 60/871,832, filed on Dec. 25, 2006.

(51) Int. Cl. G06Q 40/00

(52) U.S. Cl. 705/36 R; 705/37

(57) ABSTRACT

A method based on a platform of a variety of versions and applications of auctions having a plurality of participants and configured to progress from one auction to the next according to game theory. The method includes offering money as the sole auction product, paying of fees by the participant and providing winnings to at least one participant.

### FIELD OF THE INVENTION

The present invention generally relates to e-commerce, and more particularly to online auctions.

### BACKGROUND OF THE INVENTION

The world wide expansion and strengthening of the use of Internet in all daily activities led to various phenomena. The phenomenon of e-commerce, especially in recent years i.e. the expanded number of sites and its direct derivative, the huge growth in the extent of income and profit, is definitely remarkable. This is even stronger when considering the phenomenon of auction Websites.

Additionally, games over the Web became a phenomenon of its own, while millions are playing daily. A special, highly profitable niche of such games is the gambling sites.

On the other side of the coin, yet well appraised, is Game Theory. This popular academic branch, which happens to be connected to many daily decisions and actions, has already led a few researchers to be honored by the Nobel Prize.

One familiar aspect of such situations in Game Theory is the various auctions.

Thus, it would be advantageous to provide a system and a method for an auction format based on game theory where the sole auctioned item is money.

### SUMMARY OF THE INVENTION

Accordingly, it is a principal object of the present invention to provide a system and a method for an auction format based on game theory where the sole auctioned item is money.

It is a further principal object of the present invention to utilize the naturally expressed human eagerness of searching for the best bargain through auctions, combined with playing games, while competing with other participants and combined with the tendency to take advantage and gain by bidding wisely and tactically, based on game theory.

It is another principal object of the present invention to combine two unique elements:

1. Construct an interactive sales arena based on a platform of variable auctions leaning on game theory; and

2. Money—as the sole product to be offered for sale in all auctions.

The sole product is money, money's worth or any substitute for money. Commodities, goods, services, financial products etc. will be used as products on various applications of the sales arena based on a platform of variable auctions.

An interactive method is disclosed based on a platform of a variety of versions and applications of auctions is disclosed. The method provides for a plurality of participants and is configured to progress from one auction to the next according to game theory. The method includes offering money as the sole auction product, paying of fees by the participant and providing winnings to the winning participants. The method also provides that the sole product may be any substitute for money, including at least one of commodities, goods, services, financial products and instruments, information and data. The method also includes participation in the auctions through Short Message Service (SMS) messages. The method also includes participation in the auctions through a variety of languages.

Unlike conventional auction Websites, where a lot of products are sold through one type of auction, the present invention offers the participants a few types of auctions, while selling one unique, world wide accepted product—money.

Additional features and advantages of the invention regarding the usage of the sales arena in both e-commerce and gaming applications will become apparent from the following drawings and description.

### BRIEF DESCRIPTIONS OF THE DRAWINGS

For a better understanding of the invention in regard to the embodiments thereof, reference is made to the accompanying drawings and description, in which like numerals designate corresponding elements or sections throughout, and in which:

FIG. 1 is a schematic illustration of Auctions' manager constructed in accordance with the principles of the present invention; and

FIG. 2 is a schematic illustration showing the function of the risk management controller in a hierarchy of auctions, constructed in accordance with the principles of the present invention.

### DETAILED DESCRIPTION OF AN EXEMPLARY EMBODIMENT

The principles and operation of a method and an apparatus according to the present invention may be better understood with reference to the drawings and the accompanying description, it being understood that these drawings are given for illustrative purposes only and are not meant to be limiting.

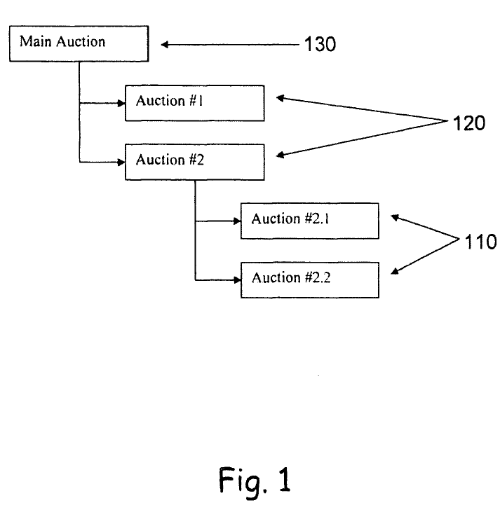

FIG. 1 is a schematic illustration of a auctions' manager, constructed in accordance with the principles of the present invention. In the auctions' manager all auctions are executed within a hierarchy in which lower level auctions 110 serve as part of the input to upper level auctions 120, and wherein the top level auction 130 is the main auction initially performed between all auction participants. The lower level auctions are started from within the main auction in order to enhance the main auction for various reasons such as private auctions to selected participants, resolution of auctions with no winners and more.

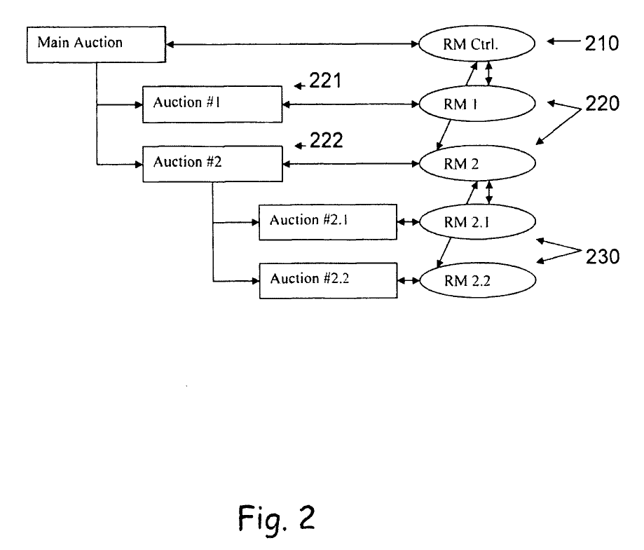

FIG. 2 is a schematic illustration showing the function of the risk management (RM) controller in a hierarchy of auctions, constructed in accordance with the principles of the present invention. Monitoring of the auctions is done by an RM controller 210 that evaluates exposure and maximum profitability and thus controls and creates the mix of the auctions parameters and participants' rewards.

The local risk management modules 220 are part of the auctions 221, 222 themselves and may affect local parameters, within their permission level.

Each local risk management module 220 also accepts inputs from other, lower level risk modules 230 as part of their decisions making process. Local risk management modules 220 may affect parameters on their own level or send “commands” downwards to affect the decisions making process of a lower level RM module 230. RM management controller 210 is also regarded as the RM Control module since it directly communicates with the external Auctions' Manager Module (not shown) that constantly analyzes the operator's exposure to risk situation.

RM controller 210, local risk management modules 220 and lower level RM modules 230 are preferably configured as one overall controller, within which are levels 210, 220 and 230. The outputs of sub-controllers 220 and 230 are analyzed to decide which:

Type of auction to run next;

The amounts; and

All other parameters, such as, but not only, the steps, the width of each step, the duration of each step and the minimal amount of offer required for each step.

Definitions:

“The operator”—This is the legal entity, that is an internal operator and that owns and operates the platform.

“Participant”—This is any person who fulfills all preconditions of any auction including, but not only, paying the required participant's fees for any certain auction.

“The offered sum”—This is the amount of money which is offered by the operator to be sold or won in the auctions.

“Product”—money or money's worth or any substitute for money.

“The offered product”—This includes other money's worth, which is offered by the operator to be sold or won in the auctions.

“Price level”—these are price steps, either ascending or descending, within each auction. The participants submit their offer in each price step (e.g. the one who submitted a bid in the highest price level is the winner).

Credits will be provided to all participants, where the total number of credits won is equal to the total fees paid by the participants.

For example $5=5 credits. Thus, a certain amount of credit is provided, equal to a certain sum of money (e.g. $1), according to a certain index or parameters. The credits can be used only for submitting bids in auctions.

Application Service Provider (ASP) model—The platform supports multiple external operators that may execute auctions using the above-described internal operator as a technology provider. These auctions are also part of the operator revenue model and are monitored and controlled by the Risk Management Controller as part of a large portfolio of auctions. Such external operators differ from the internal operator described above. The external operators do not provide the technology, but rather make use of the technology for operation of the auctions according to game theory that is provided by the internal operator.

Strategic Auction Platform The operator, or strategic controller, develops a platform for the execution of auctions being managed in a strategic way. It continuously evaluates the operator position in relation to all active and future auctions and determines its next steps regarding future auctions in terms of:

Opening/Closing Auctions & Timing—The platform decides when to open new auctions based on its past experience and strategic plan in order to maximize its long term profit. It will also decide on the auction's length. The same goes for deciding whether to prolong or close an already active auction.

Type of Auctions to be opened—The platform not only decides when to open an auction but also its type. The purpose is to create an adequate mix which will maximize the operator's profitability in the long term.

Auction parameters—At a lower level than the above decisions, some will be made within an active auction itself. Parameters such as what will be the auction's product amount, how many products to offer, what is the minimum and/or maximum number of participants, speed of bid placements, etc. will all be set as part of the strategy taken by the operator.

Rewards to participants—The decision whether to reward some participants during (or between) active auctions is also part of the strategy targeted for maximizing the profit per player (thus the platform also “plays” strategic games directly with the players). These person specific decisions may be made on a global level or at a local level (the auction itself).

The operator's platform “plays” a high level strategic game with all participants throughout the life span of the platform.

There are several targets which need to be achieved when making the decisions, some contradict with the others, so it is a Min/Max kind of problem that the system has to solve at all times:
Minimum Risk to the operator:
Exposure to losses in auction;
Foreign Exchange exposures;
Legal exposure; and
Company's image; and
Maximum Long Term Profit:
Preserving cash flow levels;
Income from interest, fees and non-bid related sources; and
Income from bid-related sources.

Taking the above approach will ensure dealing well with situations in which short term profits are substituted with long term marketing considerations that in the long run will maximize profitability while preserving adequate levels of cash flow and monitoring risky situations that may expose the operator to unexpected law suits, sudden market changes or instability in currency exchange rates.

There are two main concepts the platform implements in order to achieve the above target:

1. All auctions executed in the platform are regarded as a portfolio of investments from the operator's point of view. The operator controls the total exposure and auction parameters continuously as part of its portfolio management strategy.

2. The operator operates a cash management module to control the flow of funds including foreign currency exchange and user deposits to maximize its profitability from its auctions portfolio. Auctions parameters are set accordingly.

These computerized methods are used to support the strategic auction platform.

Auctions Manager

All auctions are executed within a hierarchy of auctions in which lower level auctions serve as part of the upper level auction inputs. The top level auction is the main auction started between the participants. All Auctions are managed by the Auctions Manager component that evaluates the reports from the Risk Management component, while auctions are being executed, taking into consideration the overall operator's business strategy.

The Auctions Manager conducts a strategic, high level, continuous analysis of the portfolio of auctions in the present and future and decides upon each auction's rules, rewards, participants and any other parameter that may affect the outcome of the specific auctions as well as the operator.

Risk Management Controller

The auctions are monitored continuously by a Risk Management Controller (RMC) module that evaluates the exposure and maximum profitability to the operator and thus controls the auctions parameters, their mix and consumer rewards. The local risk management modules are part of the auctions themselves and may affect local parameters within their permission level. The RMC works together with the Auctions Manager which controls the overall business strategy of the operator, providing the RMC with commands and inputs, and receives from it indications regarding the risk involved in each auction.

The RMC has the ability to make independent decisions regarding the hierarchy of auctions for which K is responsible, under the supervision and control of the Auctions Manager.

Generally, as mentioned above, in all auctions the sole product to be sold is money. The sum which is being offered for sale may differ from one auction to the other as well as within the same sort of auction. Obviously, the element of various elements such as sums, time, participant etc., will create the variable levels of interest as well as risk between the various auctions.

### Types of Auctions:

The English Auction

A well known auction method, in which the participant may bid on ascending certain price level (for example: each level—1$) (hereinafter: “price level”). Price level has also life duration of fixed time (for example: 5 minutes). Within life duration of each price level, participants may bid on the current amount of the price level. The winner is the first participant to be the sole bidder during the duration of any certain price level.

Note that the price level will ascend at the end of its life duration in one of the two following circumstances:

1. If no bid was submitted for a certain price level, during its life duration.

2. More than one bid was submitted for a certain price level.

Two sub-versions of the English auction will derive from the option of two versions of participant's fees. One version is the fixed fees for each bid. In such case the fees are low. The other version is the descending fees, starting with a higher fee (for example: 3$) and descending at the end of each group of ten price levels until it reaches 1$.

No reserved price or quantity of participants is planned.

The Half-Price Auction

As in the English Auction, the participant may bid on ascending certain price level (for ex.: each level—1$) (hereinafter: “price level”). However, unlike the English Auction, the auction as a whole, and not each price level, is limited by time i.e. ascending to the next price level depends on actual bid of one of the participants. Only one participant may bid in each price level. The participant's fees are not fixed and are equal to the sum which is offered by the participant in each price level. The highest bidder wins the auction. The winner will actually be charged only for half of the participant's fee of the winning offer.

The first winner receives the highest amount or the most valuable product. Optionally, a 2^{nd} and a 3^{rd} participant may also win. Once a participant bids at certain price levels (e.g. the 41^{st}, the 61^{st}), the second or third places, will respectively win as well.

The auction is limited by time. Once a bid is submitted in the last minute of the time limitation of the auction (including the last minute within the additional time), an additional 2 minutes will be added to the time limitation.

No reserved price or quantity of participants is required.

The Min/Max Auction

The winning offer is the highest or the lowest, according to the type of auction yet the sole one. Two participants who offered the same offer, pay their participant's fee, a fixed sum which is paid as a precondition for each and every offer, while the specific price transferred to a “Delay Table” for certain time. During that certain time no offer can be submitted on that specific price. Once the delay period has ended the specific offer will be returned to the auction and all participants will have the opportunity to bid again on that specific offer.

There is a reserved quantity of participants in the Min/Max auction. Once the required reserved quantity of participants is achieved, the auction will be activated for a certain time (for ex. 10 hours) within bids can be freely submitted.

In the Max auction, bids are limited to certain price level which is lower than the offered sum.

The Cycle's Auction

The auction is being conducted in 3 cycles. In the first cycle, the participants may submit any offer between 0—the amount to be won (for ex: 100$, 500$ . . . ). All bids are concealed until all bids were submitted. The highest bid in the first cycle is being published and becomes the basic price for the next cycle. The participants may then submit again where their bids in the second cycle would be between the highest bid of the first cycle and the amount of the product.

The above mechanism will be respectively executed in between the second and the third cycles. In each of the latter cycles there is not a minimum of quantity of participants, yet the only participants who are allowed to participate are those of the initial close circuit. All cycles are limited by time.

Any participant who wants to continue and take part in the latter two cycles should pay separately the participant's fees for each cycle.

The highest bidder wins the auction.

There is a reserved quantity of participants—a close circuit of participants.

The Japanese/Mixture Auction

This is a sequential auction, which is a mixture of the English auction and the Half-price auction. Participants must signal at every price level their willingness to stay in the auction and pay the current price. Unlike an English auction, each participant must bid at each level to stay in the auction. The auction concludes when only one bidder indicates his willingness to stay in. The highest bidder wins the auction. The winner will actually be charged only for half of the participant's fee of the winning offer.

As incentives to participants:

Once certain quantities of participants are bidding in certain price levels, the second or third places, respectively, will win as well. These extra sums will be divided between all participants who ended in these places.

Other option, once certain quantities of participants are bidding in certain price levels, the sum which is being offered—the winning sum—(100$,200$,500$ . . . ) will be raised upon certain criteria.

Third option is a mixed of both the above incentive options, i.e. once certain quantities of participants is bidding in certain price levels and upon certain criteria, both the winning sum will be raised and the second or third places, respectively, will win as well.

There is a reserved quantity (small) of participants in the Japanese auction.

The First Price Auction

The First Price auction is a well known and commonly used auction. It is a concealed bid auction. The participants may submit unlimited number of bids (for each bid, fixed participant's fees will be paid) until the auction reaches its time limitation. The winner is the participant who submitted the highest offer. If more than one participant bids the highest bid, a sub auction will be opened for determining the winner identity. Once the auction is ended, the participants will be notified if they won or not.

Same auction can be set without fixed participant's fees. In such case each participant's fees equals to the bid which is submitted.

Same auction while the winning offer is the highest and sole offer (same rules as Max auction without price level limitation).

The auction may be operated with or without a required minimum of participants.

The Dutch Auction

Basically, this is an auction which is planned as a part of a reward scheme. The auction is a descending auction. Each price level has life duration. In the end of duration, the bidding step descends by 1$. Like in the English Auction, participants may put a bid only on the specific price level which is currently on. The first participant to submit a bid wins. Internal Credits will be used as the participants fees.

No reserve is required.

The Sub Auction

The Sub auction is a technical assistance mechanism. This auction will be used solely for solving dispute cases within the main auctions (main auctions—English, Japanese, Cycle etc.), where two or more participants offer the same offer which turned to be the winning offer (highest or the lowest bid, according to the sort of auction).

This auction is basically similar to Max/Min auction yet with few differences:

A. There is a close circuit of participants i.e. those who offered the same winning offers in the main auctions.

B. The bids may be of any kind e.g. numerical bids, i.e. any number between for example 1-50.

C. No “delay table”. Any two or more similar bids (same number) are erased.

D. The winning offer is the highest/lowest offer. The participant who wins the sub auction automatically wins the main auction.

E. No participant's fees are required.

Each of the above auctions includes various parameters which may be changed within each parameter, or in between the parameters, creating different versions of auctions. Hereinafter is a list of a few (but not all) of the parameters:

Time—overall duration in which the auction will be activated.

Time phases—the duration of each price level (as in English auction)

Concealed/non-Concealed bids—method in which the bids are submitted and accordingly, the auction is being conducted.

Participants fees—The required amount the payment of which is a precondition for submitting each and every bid.

Credits—Credit the participants with credits which the participants can use as free offers subject to certain rules or conditions.

Rewards—Reward participants with cash rewards unbound to the offered sum.

Number of participants—number of participants that participant in the auction either certain number of participants is required or not.

Max participants—Limits the number of participants in an auction.

Number of winnings—Defines how many winnings can be in the auction.

Number of winners—Defines how many winners will be in the auction. The definition can be static in the auction or dynamic, depending on how many offers there are in the auction.

Participant's number of winnings—In cases where more than one participant stands in the winning position, defines the number of winnings that any single participant can win.

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

I claim:

1. An interactive method for participation in auctions based on a platform of various auctions for an internal operator presented by a proprietary Website, said method comprising:
offering money as the sole auction product;
paying of fees by the participant; and
providing winnings to at least one participant.

2. The method according to claim 1, wherein the auctions are offered over the Internet.

3. The method according to claim 1, wherein the auctions are offered in a plurality of languages.

4. The method of claim 1, wherein the sum which is being offered for sale may differ from one auction to the other, even within the same sort of auction,

5. The method of claim 1, wherein the parameters and elements comprising at least time and number of participants, create the variable levels of interest, skill as well as practice between the various auctions.

6. The method of claim 1, further comprising supporting multiple external operators, wherein said external operators are client/sellers executing auctions using said internal operator the proprietary Website as a technology provider in the manner of an Application Service Provider (ASP) model.

7. The method of claim 6, wherein said client/sellers are provided with a Risk Management Controller designed to increase said client/seller's profitability.

8. The method of claim 1, wherein the sole product is any substitute for money, comprising at least one of commodities, goods, services, financial products and instruments, information and data.

9. The method of claim 1, wherein participation in the auctions is enabled through Short Message Service (SMS) messages.

10. The method of claim 1, wherein participation in auctions is enabled by cellular platforms supported by standard browsers.

11. The method of claim 1, further comprising winnings based on providing credits to all participants, wherein the total number of credits won is equal to the total fees paid by the participants.

12. The method of claim 11, wherein said credits will be used for submitting bids in future auctions.

13. The method of claim 7, wherein the platform for the Internet is configured for cellular devices.

14. The method of claim 13, wherein the platform is configured for interactive communications media.

15. The method of claim 1, wherein progress from one auction to the next is according to game theory
